(19) United States
(12) Patent Application Publication
(10) Pub. No.: US 2016/0012357 A1
(43) Pub. Date: Jan. 14, 2016

(54) Automated Space Layout Based on Business Constraints

(71) Applicant: INTERNATIONAL BUSINESS MACHINES CORPORATION, Armonk, NY (US)

(72) Inventor: Douglas A. Wood, Raleigh, NC (US)

(73) Assignee: INTERNATIONAL BUSINESS MACHINES CORPORATION, Armonk, NY (US)

(21) Appl. No.: 14/327,124

(22) Filed: Jul. 9, 2014

(51) Int. Cl. G06Q 10/06; G06F 17/50

(52) U.S. Cl. CPC G06Q 10/067; G06F 17/5009

(57) ABSTRACT

A system and computer-usable medium are disclosed for automating the layout of a space layout based upon organization requirements and space constraints. An integrated workplace management system (IWMS) receives a set of organization structure data associated with an organization and a building information model (BIM) containing a set of space constraint data associated with a target space. The set of organization structure data and the set of space constraint data are then processed by the IWMS to automatically generate a space layout corresponding to the target space.

### BACKGROUND OF THE INVENTION

1. Field of the Invention

The present invention relates in general to the field of computers and similar technologies, and in particular to software utilized in this field. Still more particularly, it relates to a method, system and computer-usable medium for automating the layout of a space layout based upon organization requirements and space constraints.

2. Description of the Related Art

Large organizations often have portfolios of hundreds, or even thousands, of buildings that they either rent or own. For many of these organizations, real estate is their single largest capital investment, which means that increased efficiency in the utilization of these assets can produce corresponding financial and operational benefits. It is also common for a significant portion of these organization's real estate portfolio to be commercial office space, which is typically built as a shell with all of the building's structural, heavy mechanical, electrical, and plumbing in place, but with an unfinished interior. Once these spaces are ready to be occupied, the interior is then built out to meet the current requirements. Furthermore, it is not uncommon for a building's interior to be demolished and rebuilt multiple times during the lifetime of the structure.

Space planning is the discipline of managing an organization's space requirements against its real estate portfolio. Changing demographics, business requirements, or other factors may result in frequent shifts in the usage of a given space. Changes in the cost of real estate may also make associated changes in space utilization advantageous. This creates a dynamic optimization challenge of how to best fit an organization's space requirements either into an existing real estate portfolio, or alternatively, how to alter the portfolio. Known approaches to this challenge include the implementation of an integrated workspace management system (IWMS), such as TRIRIGA®, available from International Business Machines (IBM®) of Armonk, N.Y. Such systems generally provide a variety of useful information, such as space utilization metrics and associated gross energy costs for a building. However, the optimization of a building's space layout and interior design is more typically achieved through manual processes that are more art than science.

One approach to this issue is Building Information Modeling (BIM). During the design process, a complete and detailed digital model is created in a computer-readable format, such as Industry Foundation Classes (IFCs), that include various details associated with a building or a group of buildings. Examples of such models include those created in Revit Architecture® software available from Autodesk®, Inc. of San Rafael, Calif., or MicroStation® software, available from Bentley Systems®, Inc. of Exton, Pa. The model is subsequently updated during construction and is ultimately available as an “as built” configuration. Furthermore, there are various known algorithms that can be used to optimize the layout of subspaces within a larger space. However, no known approach combines the physical constraints of a given building, and the business needs of the organization using the space, to provide an automated layout of business spaces.

### SUMMARY OF THE INVENTION

A method, system and computer-usable medium are disclosed for automating the layout of a space layout based upon organization requirements and space constraints. In various embodiments, an integrated workplace management system (IWMS) receives a first set of organization structure data associated with an organization and a first building information model (BIM) containing a first set of space constraint data associated with a first space. The first set of organization structure data and the first set of space constraint data are then processed by the IWMS to automatically generate a first space layout corresponding to the first space.

In one embodiment, the IWMS receives a second BIM containing a second set of space constraint data associated with a second space. The first set of organization structure data and the second set of space constraint data are then processed by the IWMS to automatically generate a second space layout corresponding to the second space. Comparison operations are then performed to compare the first space layout to the second space layout, which results in the generation of a first set of space utilization metrics respectively associated with the first space layout and the second space layout. The first set of space utilization metrics are then processed with the first set of organization structure data to determine whether the first or second space layout is the optimum space layout for the organization.

In one embodiment, revisions are made to the first set of organization structure data, which results in the generation of a second set of organization structure date. The resulting second set of organization structure data is then processed by the IWMS with the first and second sets of space constraint data to automatically generate a third space layout corresponding to the first space and a fourth space layout corresponding to the second space. Comparison operations are then performed to compare the third space layout to the fourth space layout, which results in the generation of a second set of space utilization metrics respectively associated with the third space layout and the fourth space layout. The second set of space utilization metrics are then processed with the second set of organization structure data to determine whether the third or fourth space layout is the optimum space layout for the organization.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 is a simplified organization chart used in the performance of automated space layout operations associated with a marketing organization;

FIG. 3 is a simplified table of space requirements data associated with the marketing organization depicted in the organization chart shown in FIG. 2;

FIGS. 4A-4B show a space layout automatically generated from the table of space requirements data shown in FIG. 3;

FIG. 5 is a simplified organization chart used in the performance of automated space layout operations associated with a call center organization;

FIG. 6 is a simplified table of space requirements data associated with the call center organization depicted in the organization chart shown in FIG. 5;

FIG. 7 shows a space layout automatically generated from the table of space requirements data shown in FIG. 6; and

FIGS. 8A-8B are a generalized flowchart of the performance of automated space layout operations.

### DETAILED DESCRIPTION

A method, system and computer-usable medium are disclosed for automating the layout of a space layout based upon organization requirements and space constraints. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

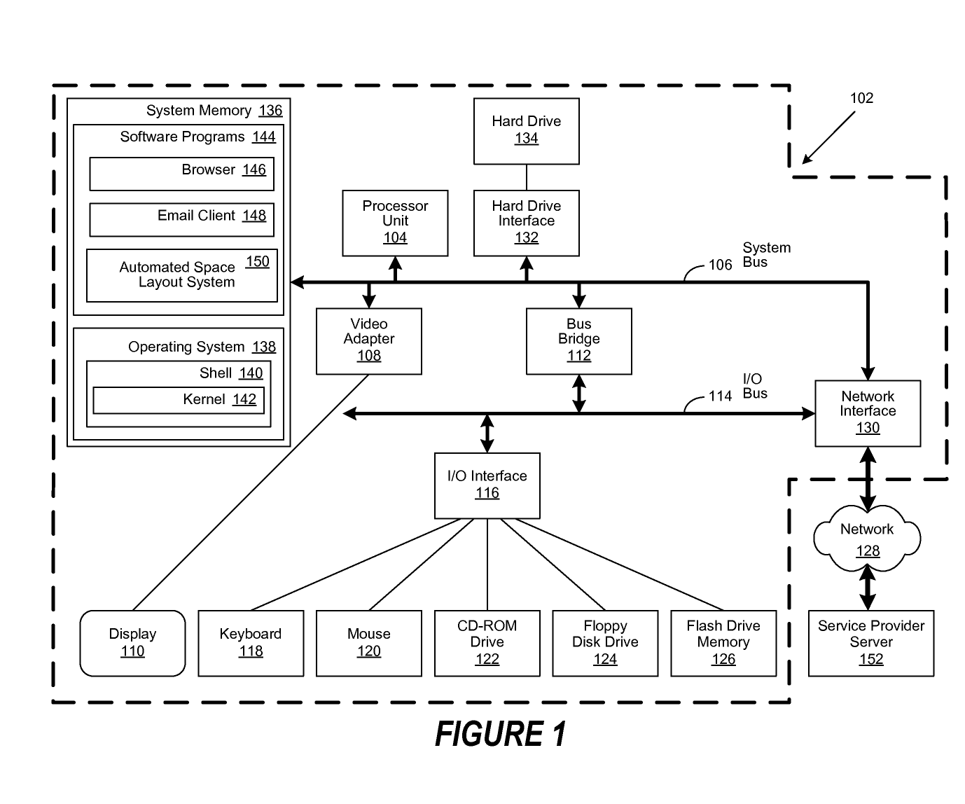

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management. Software programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. In various embodiments, software programs 144 may also include an automated space layout system 150. In these and other embodiments, the automated space layout system 150 includes code for implementing the processes described hereinbelow. In one embodiment, client computer 102 is able to download the automated space layout system 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit, scope and intent of the present invention.

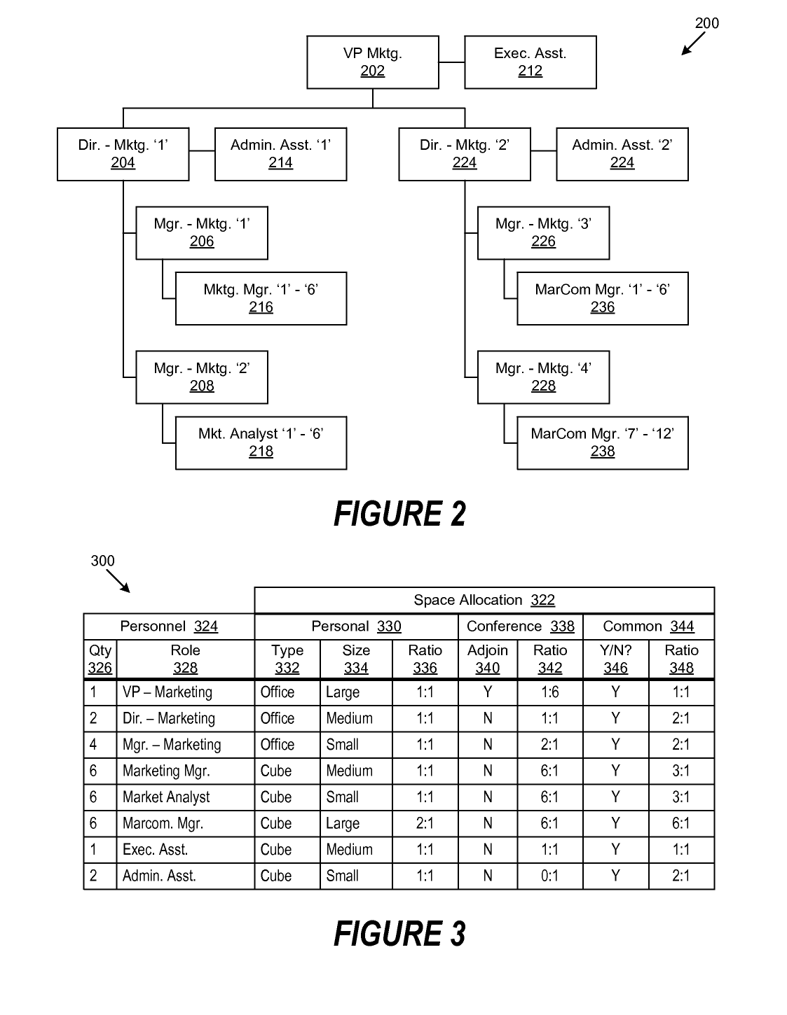

FIG. 2 is a simplified organization chart implemented in accordance with an embodiment of the invention for the performance of automated space layout operations associated with a marketing organization. In this embodiment, the organization chart 200 depicts the structure of a marketing organization that is headed by a Vice President (VP) of Marketing 202, who has direct reports that include an Executive Assistant 212 and Directors of Marketing ‘1’ 204 and ‘2’ 224.

Likewise, the Director of Marketing ‘1’ 204 has direct reports that include an Administrative Assistant ‘1’ 214 and Managers of Marketing ‘1’ 206 and ‘2’ 208. In turn, the Managers of Marketing ‘1’ 206 and ‘2’ 208 respectively have six direct reports each that include Marketing Managers ‘1’ through ‘6’ 216, and Market Analysts ‘1’ through ‘6’ 218. The Director of Marketing ‘2’ 224 likewise has direct reports that include an Administrative Assistant ‘2’ 234 and Managers of Marketing ‘3’ 226 and ‘4’ 228. In turn, the Managers of Marketing ‘3’ 226 and ‘4’ 228 respectively have six direct reports each that include Marketing Communication (MarCom) Managers ‘1’ through ‘6’ 236, and Market Analysts ‘1’ through ‘6’ 238.

In various embodiments, organization structure data associated with the organization chart 200 is stored and managed in an Integrated Workspace Management System (IWMS). As used herein, organization structured data broadly refers to data associated with an organization structure, such as the organization chart shown in FIG. 2. As such, it can be used to define how activities such as task allocation, coordination and supervision are directed towards the achievement of organizational aims. In addition, it can provide a perspective of how individuals perceive their organization and its environment. Those of skill in the art will realize that an organization may be structured in many different ways, depending on their objectives. Further, the structure of an organization often determines the modes in which it operates and performs. It will likewise be appreciated that various organizational structures allow the expressed allocation of responsibilities for different functions and processes to different entities such as a branch, a department, a workgroup, or an individual. In various embodiments, organization structure data includes space requirement and other information associated with an individual's role, such as the roles shown depicted in the organization chart shown in FIG. 2.

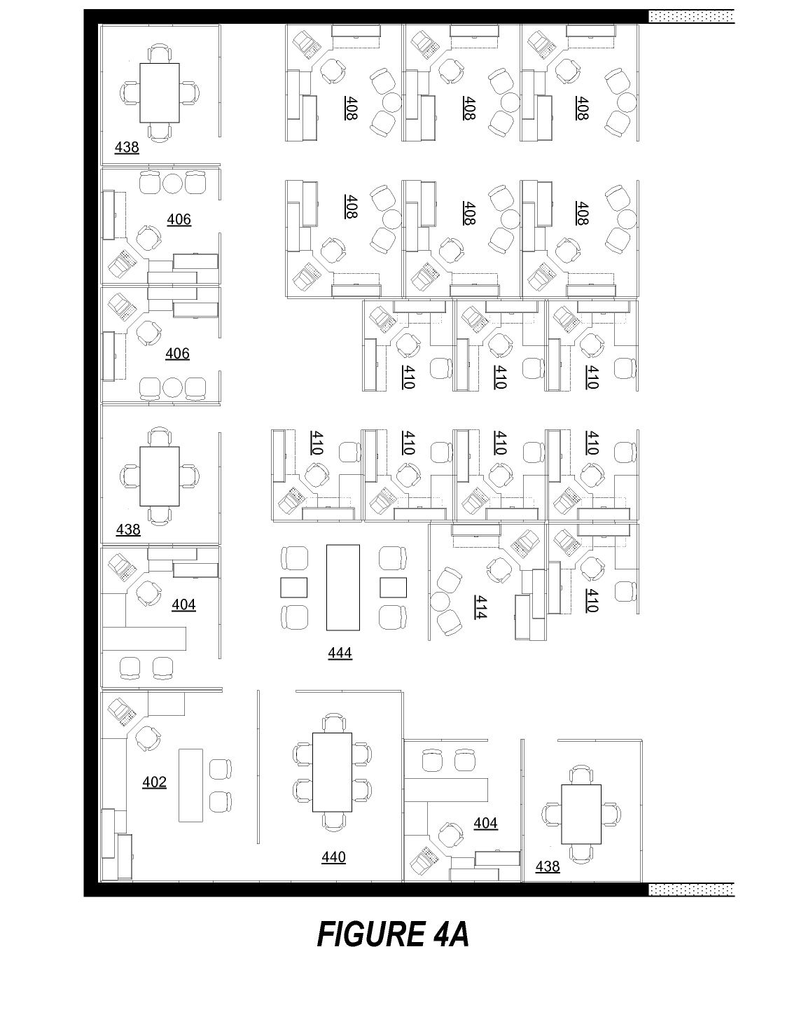

FIG. 3 is a simplified table of space requirements data implemented in accordance with an embodiment of the invention for the performance of automated space layout operations associated with the marketing organization depicted in the organization chart shown in FIG. 2. In this embodiment, the table of space requirements data 300 shows a listing of personnel 324 data and associated space allocation 322 data. As shown in FIG. 3, the personnel 324 data includes quantity 326 data associated with the number of each organizational role 328 depicted in the organization chart 200 shown in FIG. 2. As likewise shown in FIG. 3, the associated space allocation 322 data includes personal space 330, conference room 338, and common area 344 data associated with each organizational role 328. Likewise, the personal space 330 data includes space type 332, space size 334, and occupancy ratio 336 data. The conference room 338 data likewise includes adjoining space 340 data and allocation ratio 342 data, and the common area 344 data includes area allocation 344 and area ratio 348 data.

In various embodiments, the associated space allocation 322 data may also include space entitlement rules corresponding to various data associated with a predetermined position, organizational role 328, user identity, or some combination thereof. Such space entitlement rules may include whether a predetermined position, organizational role 328, or user identity is entitled to an office or a cube, its associated minimum area, placement (e.g., located in a corner), or feature (e.g., has a window). Other space entitlement rules may include whether or not a predetermined space can be shared, and if so, by whom.

For example, the table of space requirements data 300 in this embodiment shows that the role 328 of “VP-Marketing” is entitled to a personal space 330 that is defined as a space type 332 of “office,” whose space size 334 is “large,” and has an occupancy ratio 336 of 1:1, signifying that the entitled space is not shared. In contrast, the table of space requirements data 300 likewise shows that the role 328 of “MarCom Manager” is entitled to a personal space 330 that is defined as a space type 332 of “cube,” whose space size 334 is “large,” and has an occupancy ratio 336 of 1:2, signifying that the entitled space is shared with another individual with the role 328 of “MarCom Manager”.

Likewise, the space entitlement rules may include entitlement to an adjacent conference room 338, common areas 344, special needs such as handicapped access, or physical security requirements. For example, in this embodiment, the table of space requirements data 300 shows that the role 328 of “VP-Marketing” is entitled to the use of a conference room 338 that is an adjoining space 340, and has an allocation ratio of 1:6, signifying that the adjoining conference room can accommodate six individuals. In contrast, the table of space requirements data 300 shows that the role 328 of “MarCom Manager” is entitled to the use of a conference room 338 that is not an adjoining space 340, and has an allocation ratio 342 of 6:1, signifying that the non-adjoining conference room space is allocated at the ratio of one conference room for every six individuals that have the role 328 of “MarCom Manager.” Likewise, the table of space requirements data 300 shows that the role 328 of “VP-Marketing” and “MarCom Manager” are both entitled to use of common area 344 space at the respective occupancy ratio 348 of 1:1 and 6:1.

The space entitlement rules may likewise include rules related to special electrical, plumbing, HVAC, floor loading requirements and other constraints. Other space entitlement rules may include how regular a space needs to be (e.g., pillars in the interior, ‘L’ shaped, intrusions into walls, etc.), as well as specified increases in area to offset such defects. Likewise, guidelines for common space, such as for conference rooms and break rooms, and code and legal requirements governing space usage by geographic region may be included in the space entitlement rules. Skilled practitioners of the art will recognize that many such space entitlement rules are possible and the foregoing is not intended to limit the spirit, scope or intent of the invention.

In various embodiments, the space entitlement rules are stored and managed in an Integrated Workspace Management System (IWMS). In certain embodiments, the data shown in the table of space requirement data 300 is likewise stored and managed in an IWMS. In these and other embodiments, the IWMS may likewise be implemented to store and manage historic and predictive information related to the cost of owning and operating individual buildings within a real estate portfolio. Examples of such information may include lease and mortgage costs, tax rates, energy and utility costs, and maintenance costs. In certain embodiments, the IWMS may be implemented to store and manage information associated with the cost of assigning an individual to a target space or building. Examples of such information may include prevailing wages by the type of position or role, wage taxes, and overhead such as parking. It will be appreciated that many such embodiments and examples are possible and the foregoing is not intended to limit the spirit, scope or intent of the invention.

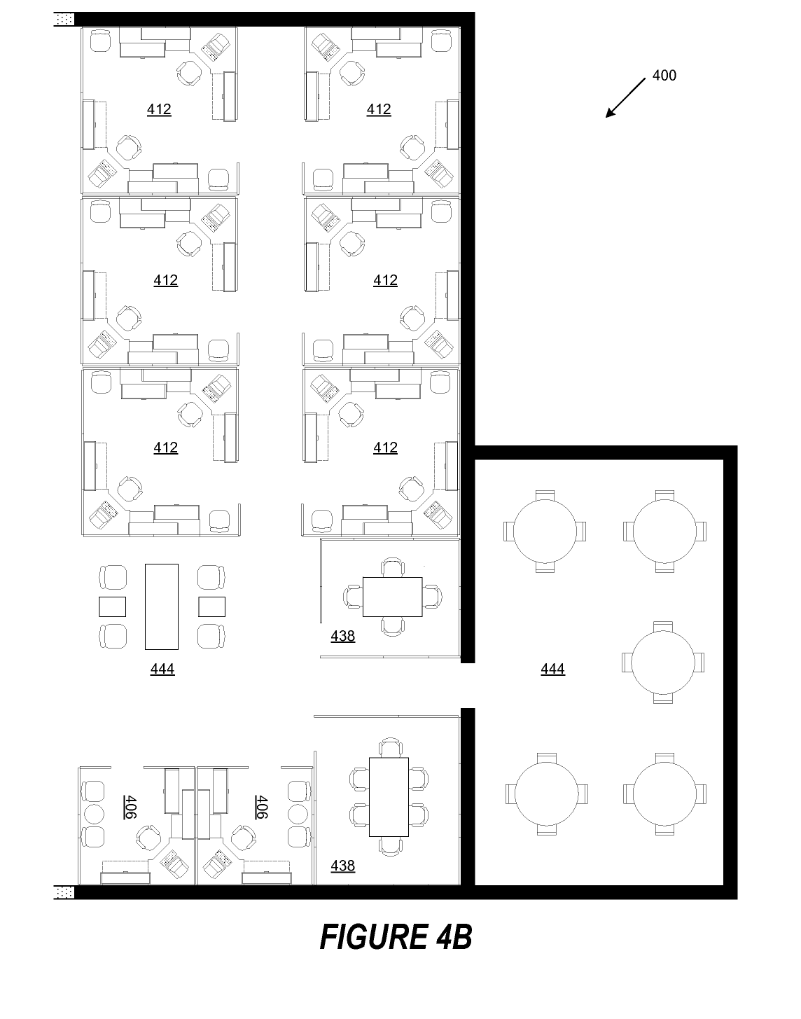

FIGS. 4A-4B show a space layout automatically generated in accordance with an embodiment of the invention from the table of space requirements data shown in FIG. 3. In various embodiments, organization structure data associated with a target organization is processed with space constraint data associated with a target space to automate a space layout. In certain embodiments, the organization structure data includes space requirements data, such as the data contained in the table of space requirements data 300 shown in FIG. 3. In these embodiments, the space requirements data, the organization structure data, or both, may be stored and managed in an Integrated Workspace Management System (IWMS).

In various embodiments, the space constraint data is likewise stored and managed in a Building Information Model (BIM). As used herein, a BIM broadly refers to a shared knowledge resource for information about a predetermined space, such as a building, that provides a reliable basis for decisions throughout its lifecycle, from earliest conception through demolition. As such, various BIMs may represent a design as combinations of “objects,” which may be vague and undefined, generic or product-specific, solid shapes or void-space oriented (e.g., the shape of a room), each of which carry their geometry, relations and attributes. Skilled practitioners of the art will be aware that known BIM design tools allow extraction of different views from various implementations of a BIM for drawing production and other uses. Furthermore, these different views are automatically consistent, being based on a single definition of each object instance. In these embodiments, the resulting auto-generated space layout conforms to the physical constraints of the target space and the space requirements of the organization intended to use the space.

In various embodiments, the space constraint data may include data related to various architectural and physical characteristics of the target space, such as its shape and associated dimensions. In these embodiments, the space constraint data may likewise include data related to the shape, dimensions, structural elements, and other aspects of the building shell that contains the target space. Likewise the space constraint data may include data related to existing internal space divisions, the position of elevators, escalators, restrooms, kitchen facilities and other building services that are typically permanent. In certain embodiments, the space constraint data may include data related to architectural data associated with the position and capacity of electrical and HVAC services, and the structural parameters of the target space. In various embodiments, the space constraint data may include financial data, such as the average cost per square foot or associated utility costs. In certain embodiments, the space constraint data may include legal data, such as the contractual terms of a lease or legal restrictions on the use of the space. Those of skill in the art will recognize that many such embodiments are possible and the foregoing is not intended to limit the spirit, scope or intent of the invention.

In various embodiments, automated space layout operations are begun with the selection of a target organization, such as the organization depicted in the organization chart shown in FIG. 2. In certain embodiments, the target organization may be associated with an actual organization or a shell organization structure. In these embodiments, the shell organization may be represented by an empty organization chart specifying the number of individual positions, their roles, and associated reporting structure, but not identified or named individuals.

Once a target organization is selected, an associated target space is selected. In various embodiments, the target space is selected through the implementation of a two-dimensional (2D) or three-dimensional (3D) graphical representation of one or more target spaces within a graphical user interface (GUI) familiar to skilled practitioners of the art. In certain embodiments, the target space is selected through the implementation of a text-based search, likewise familiar to those of skill in the art. It will be appreciated that certain target spaces may be pre-assigned or marked as unalterable.

Organization structure data associated with the target organization and space constraint data associated with the target space is then retrieved and processed, as described in greater detail herein, to auto-generate a space layout. In various embodiments, the processing of the organization structure data and the space constraint data is performed by an IWMS. In these embodiments, the resulting auto-generated space layout meets predetermined requirements specified in the IWMS system. In certain embodiments, the resulting automated space layout is then stored in a Building Information Model (BIM), described in greater detail herein.

Referring now to FIGS. 4A-4B, the data contained in the table of space requirements data 300 shown in FIG. 3 has been processed with space constraint data associated with a target space to auto-generate a space layout 400. As shown in FIGS. 4A-4B, large 402, medium 404, and small 406 offices are respectively allocated to the VP-Marketing, and each Director-Marketing and Manager-Marketing. Likewise, medium 408 cubes are individually allocated to each Marketing Manager and the Executive Assistant, while small 410 cubes are individually allocated to each Marketing Analyst and Administrative Assistant. As likewise shown in FIGS. 4A-4B, a large 412 cube is allocated for every two MarCom Managers. Likewise, the VP-Marketing is allocated an adjoining 240 conference room 440, while non-adjoining 240 conference rooms 438 and common areas 444 are respectively allocated according to the allocation ratios 342 and occupancy ratios 348 defined in the table of space requirements data 300 shown in FIG. 3.

In various embodiments, the resulting auto-generated space layout 400 is compared to one or more other space layouts by performing space layout comparison operations familiar to those of skill in the art. In these embodiments, the performance of the space layout comparison operations results in the generation of various space utilization metrics respectively associated with each of the compared space layouts. As an example, the space utilization metrics may indicate that a second space layout has provides a higher ratio of usable space to available space. However, the space utilization metrics may also indicate that the first space layout has a lower overall cost. Skilled practitioners of the art will recognize that many such examples of space layout comparisons and associated space utilization metrics are possible and that the foregoing is not intended to limit the spirit, scope or intent of the invention.

In these and other embodiments, it may be decided to revise the auto-generated space layout 400. If so, then space layout revision operations, likewise familiar to those of skill in the art, are performed to generate one or more revised space plans, which in various embodiments are then stored in a BIM. In various embodiments, the auto-generated space plan 400 is revised through the use of BIM design tools and approaches familiar to skilled practitioners of the art. In these embodiments, the revisions to the auto-generated space plan 400 may include the creation of spaces, sub-spaces interior walls, partitions, cubes, and so forth. In various embodiments, the revisions to the auto-generated space plan 400 are performed automatically, manually, or a combination of the two.

In certain embodiments, the revised space plan may be evaluated to determine whether it meets the predetermined organization structure requirements and constraints of the target space. If not, then spaces that are deficient can either be described in an error listing or visually flagged within the BIM. In various embodiments, it may not be possible to auto-generate a space layout that meets the requirements of the target organization and constraints associated with the target space. In these embodiments, a report is automatically generated describing why. In various embodiments, quality metrics associated with the auto-generated space layout 400 are generated, which may include the ratio of functional space to total space used. Likewise, the quality metrics may include how much the actual functional space exceeds the theoretical minimum to meet the organization structure requirements and target space constraints, the percentage of existing interior space reused, and an index of how contiguous the spaces are.

In various embodiments, various space planning templates are implemented to encapsulate one or more predetermined space management philosophies and assist in guiding the auto-generation of a space layout. Examples of such space management philosophies include implementation of grids (e.g., cube or office), open workspace cubes, team environments with offices or cubes arranged around common collaboration space, and team cubes with one or more adjoining supervisor's office.

In various embodiments, auto-generated or existing space layouts may be analyzed for operating costs using the above factors. In these and other embodiments, these same space layouts may also be analyzed for transition costs, include factors such as the cost to demolish any existing interiors and build out new designs. These factors may likewise include the cost of moving employees or other individuals to or from a nearby space, the cost of relocating or hiring new staff if employees and other individuals are moved greater distances, or cascade costs if an existing team is to be displaced. Those of skill in the art will recognize that the ability to analyze and compare various layout options allows a portfolio of buildings to be automatically searched for buildings that are suitable for an organization's space requirements.

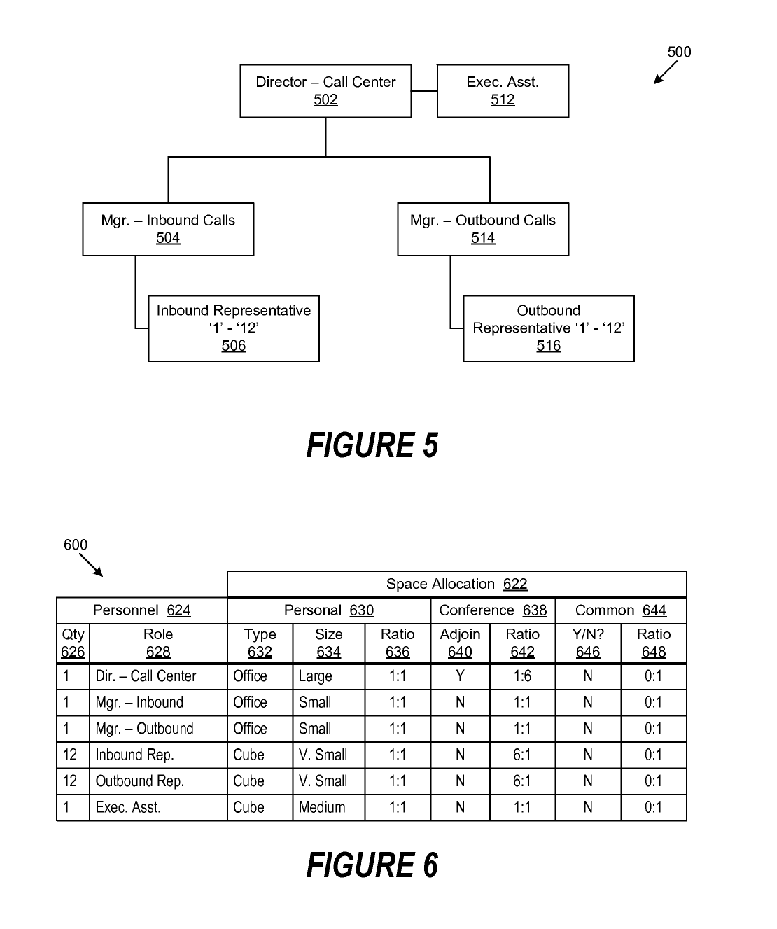

FIG. 5 is a simplified organization chart implemented in accordance with an embodiment of the invention for the performance of automated space layout operations associated with a call center organization. In this embodiment, the organization chart 500 depicts the structure of a call center organization that is headed by a Director-Call Center 502, who has direct reports that include an Executive Assistant 512 and Managers of Inbound Calls 504 and outbound calls 514. Likewise, the Managers of Inbound Calls 504 and Outbound Calls 514 each have twelve direct reports that respectively include Inbound Representatives ‘1’ through ‘12’ 506 and Outbound Representatives ‘1’ through ‘12’ 516. In various embodiments, organization structure data associated with the organization chart 500 is stored and managed in an Integrated Workspace Management System (IWMS).

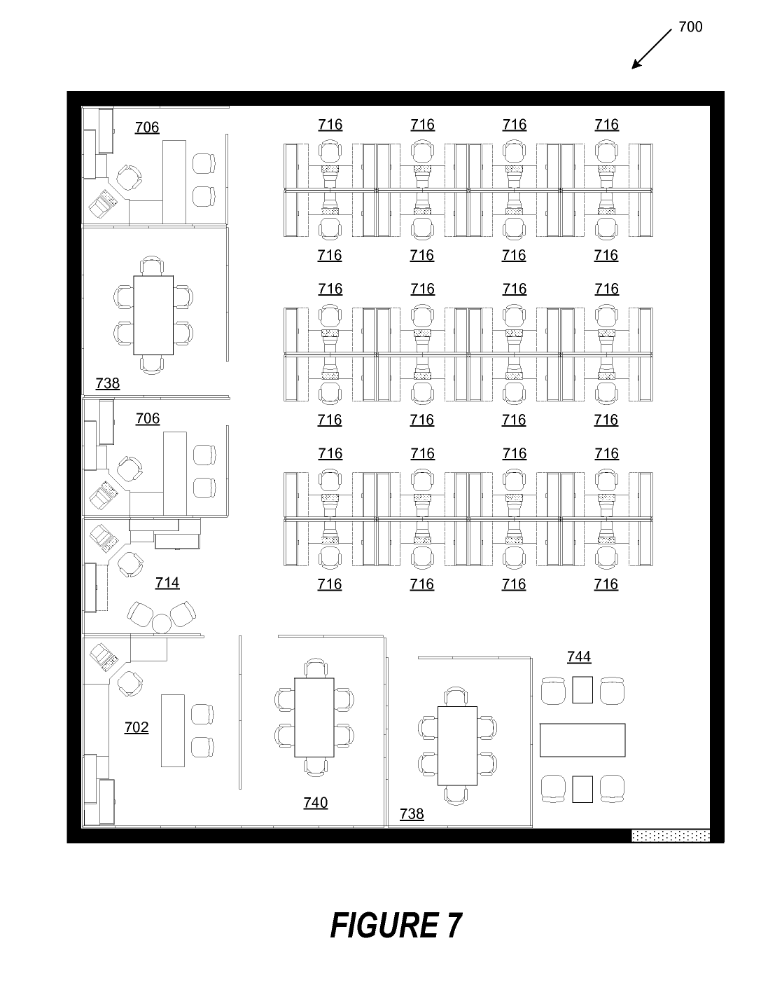

FIG. 6 is a simplified table of space requirements data implemented in accordance with an embodiment of the invention for the performance of automated space layout operations associated with the call center organization depicted in the organization chart shown in FIG. 5. In this embodiment, the table of space requirements data 600 shows a listing of personnel 624 data and associated space allocation 622 data. As shown in FIG. 6, the personnel 624 data includes quantity 626 data associated with the number of each organizational role 628 depicted in the organization chart 500 shown in FIG. 5. As likewise shown in FIG. 6, the associated space allocation 622 data includes personal space 630, conference room 638, and common area 644 data associated with each organizational role 628. Likewise, the personal space 630 data includes space type 632, space size 634, and occupancy ratio 636 data. The conference room 638 data likewise includes adjoining space 640 data and allocation ratio 642 data, and the common area 644 data includes area allocation 644 and area ratio 648 data.

In this embodiment, the table of space requirements data 600 shows that the role 628 of “Director-Call Center” is entitled to a personal space 630 that is defined as a space type 632 of “office,” whose space size 634 is “large,” and has an occupancy ratio 636 of 1:1, signifying that the entitled space is not shared. In contrast, the table of space requirements data 600 likewise shows that the roles 628 of “Inbound Representative” and “Outbound Representative” are both entitled to a personal space 630 that is defined as a space type 632 of “cube,” whose space size 634 is “very small,” and has an occupancy ratio 636 of 1:1, signifying that the entitled space is not shared with another individual with the role 628 of either “Inbound Representative” or “Outbound Representative.”

Likewise, the table of space requirements data 600 shows that the role 628 of “Director-Call Center” is entitled to the use of a conference room 638 that is an adjoining space 640, and has an allocation ratio of 1:6, signifying that the adjoining conference room can accommodate six individuals. In contrast, the table of space requirements data 600 shows that the role 628 of “Inbound Representative” or “Outbound Representative” is entitled to the use of a conference room 638 that is not an adjoining space 640, and has an allocation ratio 642 of 6:1, signifying that the non-adjoining conference room space is allocated at the ratio of one conference room for every six “Inbound Representatives” or “Outbound Representatives.” Likewise, the table of space requirements data 600 shows that the role 628 of “Director-Call Center” and “Inbound Representative” or “Outbound Representative” are each entitled to use of common area 644 space at the respective occupancy ratio 648 of 1:1 and 6:1.

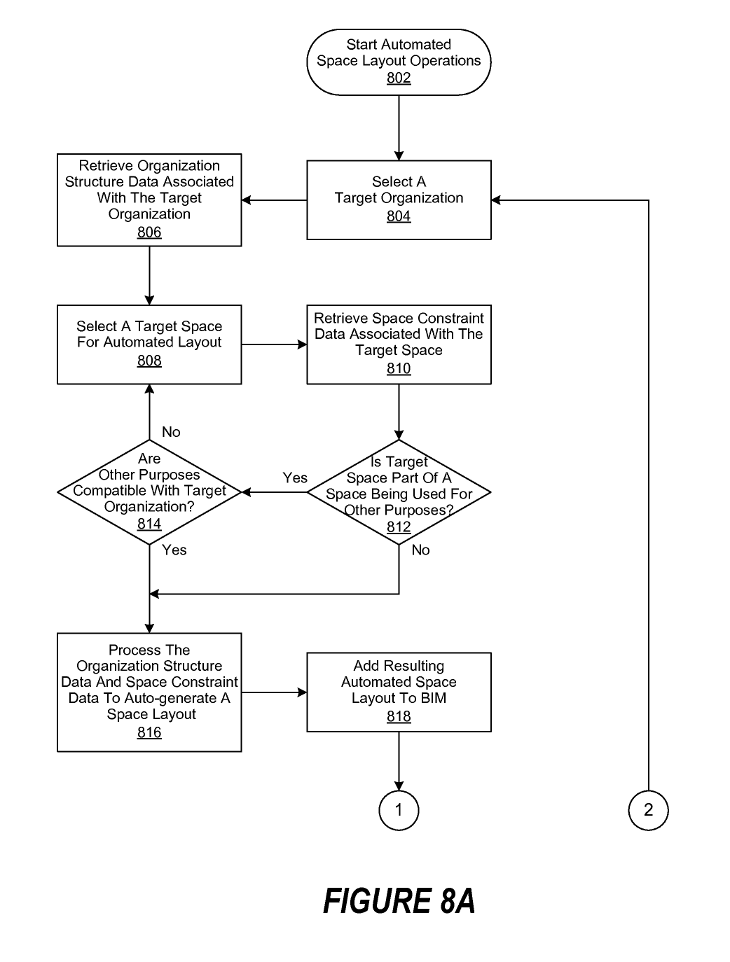

FIG. 7 shows a space layout automatically generated in accordance with an embodiment of the invention from the table of space requirements data shown in FIG. 6. In this embodiment, the data contained in the table of space requirements data 600 shown in FIG. 6 has been processed with space constraint data associated with a target space to auto-generate a space layout 700. As shown in FIG. 7, large 702 and small 706 offices are respectively allocated to the VP-Marketing, and each Manager-Inbound and Manager-Outbound. Likewise, a medium 714 cube is allocated to the Executive Assistant, while very small 716 cubes are individually allocated to each Inbound Representative and Outbound Representative. As likewise shown in FIG. 7, the Director-Call Center is allocated an adjoining 640 conference room 740, while non-adjoining 640 conference rooms 738 and common areas 744 are respectively allocated according to the allocation ratios 642 and occupancy ratios 648 defined in the table of space requirements data 600 shown in FIG. 6.

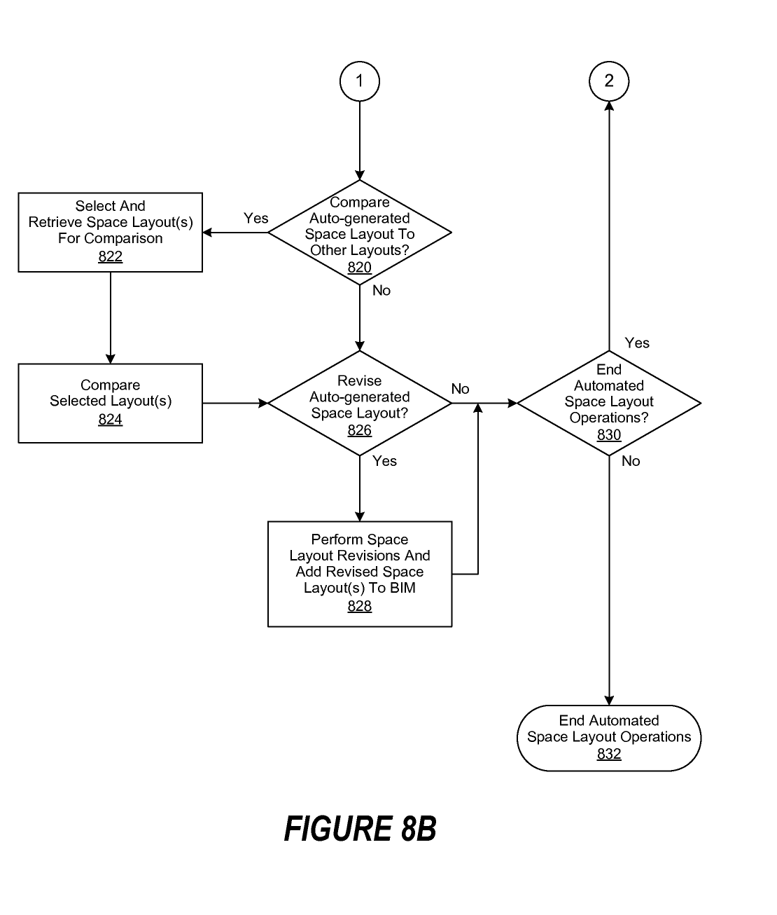

FIG. 8 is a generalized flowchart of the performance of automated space layout operations implemented in accordance with an embodiment of the invention. In this embodiment, automated space layout operations are begun in step 802, followed by the selection of a target organization in step 804. Once the target organization is selected, associated organization structure data, described in greater detail herein, is retrieved in step 806. A target space is then selected in step 808, followed by the retrieval of associated space constraint data, likewise described in greater detail herein, in step 810.

A determination is then made in step 812 whether the selected target space is part of a space that is currently being used for other purposes. If so, a determination is made in step 814 whether the other purposes the target space is being used for is compatible with the target organization selected in step 804. As an example, a portion of a target space may currently be used for manufacturing purposes and the target organization is a call center organization. As a result, it may be determined that noise from manufacturing processes currently being performed in the target space may be intrusive, or counterproductive, to the operation of the call center operation. As another example, a portion of the target space may be used by a marketing organization. In this example, it may be determined that the colocation of the marketing organization and the call center organization is not only compatible, but desirable. It will be appreciated that many such examples are possible and the foregoing is not intended to limit the spirit, scope or intent of the invention.

If it is determined that the other purposes the target space is being used for are not compatible with the target organization, then the process is continued, proceeding with step 808. Otherwise, or if it was determined in step 812 that the target space is not being used for other purposes, then the organization structure data and the space constraint data is processed in step 816, as described in greater detail herein, to auto-generate a space layout. The resulting space layout is then added to a target Building Information Model (BIM) in step 818.

A determination is then made in step 820 whether to compare the auto-generated space layout to other space layouts. If so, then one or more space layouts are selected and retrieved in step 822 and space layout comparison operations familiar to those of skill in the art are performed in step 824. Thereafter, or if it was determined in step 820 not to compare the auto-generated space layout to other space layouts, then a determination is made in step 826 whether to revise the auto-generated space layout. If so, then space layout revision operations are performed in step 828 to generate one or more revised space plans, which are then stored in a BIM. Thereafter, or if it was determined in step 826 to not revise the auto-generated space layout, a determination is made in step 830 whether to end automated space layout operations. If not, the process is continued, proceeding with step 804. Otherwise, automated space layout operations are ended in step 832.

Although the present invention has been described in detail, it should be understood that various changes, substitutions and alterations can be made hereto without departing from the spirit and scope of the invention as defined by the appended claims.

1-6. (canceled)

7. A system comprising:
a processor;
a data bus coupled to the processor; and
a computer-usable medium embodying computer program code, the computer-usable medium being coupled to the data bus, the computer program code used for automating the layout of a space and comprising instructions executable by the processor and configured for:
receiving a first set of organization structure data associated with an organization, the first set of organization structure data being received by an integrated workplace management system (IWMS);
receiving a first building information model (BIM) comprising a first set of space constraint data associated with a first space, the first BIM being received by the IWMS; and
processing the first set of organization structure data and the first set of space constraint data to automatically generate a first space layout corresponding to the first space, the processing performed by the IWMS.

8. The system of claim 7, wherein the organization structure data comprises space entitlement rules associated with at least one member of the set of:
the organizational role of a user of a space;
the personal identity of a user of a space;
accommodation for predetermined needs associated with a user of a space;
the type of an allocated space;
the size of an allocated space;
the shape of an allocated space;
the placement of an allocated space;
costs associated with an allocated space;
features associated with an allocated space;
whether an allocated space is shared;
architectural requirements associated with an allocated space; and
allocation of common spaces.

9. The system of claim 7, wherein the space constraint data comprises at least one member of the set of:
physical constraint data;
architectural constraint data;
financial constraint data; and
legal constraint data.

10. The system of claim 7, further comprising:
receiving a second BIM comprising a second set of space constraint data associated with a second space, the second BIM received by the IWMS;
processing the first set of organization structure data and the second set of space constraint data to automatically generate a second space layout corresponding to the second space, the processing performed by the IWMS;
performing comparison operations to compare the first space layout to the second space layout, the performance of the comparison operations generating a first set of space utilization metrics respectively associated with the first space layout and the second space layout.

11. The system of claim 10, further comprising:
processing the first set of space utilization metrics with the first set of organization structure data to determine the optimum space layout.

12. The system of claim 11, further comprising:
processing the first set of organization structure data to generate a second set of organization structure date, the processing comprising performing revisions to the first set of organization structure data;
processing the second set of organization structure data with the first and second sets of space constraint data to automatically generate a third space layout corresponding to the first space and a fourth space layout corresponding to the second space, the processing performed by the IWMS;
performing comparison operations to compare the third space layout to the fourth space layout, the performance of the comparison operations generating a second set of space utilization metrics respectively associated with the third space layout and the fourth space layout; and
processing the second set of space utilization metrics with the second set of organization structure data to determine the optimum space layout.

13. A computer-readable storage medium embodying computer program code, the computer program code comprising computer executable instructions configured for:
receiving a first set of organization structure data associated with an organization, the first set of organization structure data being received by an integrated workplace management system (IWMS);
receiving a first building information model (BIM) comprising a first set of space constraint data associated with a first space, the first BIM being received by the IWMS; and
processing first set of organization structure data and the first set of space constraint data to automatically generate a first space layout corresponding to the first space, the processing being performed by the IWMS.

14. The computer-readable storage medium of claim 13, wherein the organization structure data comprises space entitlement rules associated with at least one member of the set of:
the organizational role of a user of a space;
the personal identity of a user of a space;
accommodation for predetermined needs associated with a user of a space;
the type of an allocated space;
the size of an allocated space;
the shape of an allocated space;
the placement of an allocated space;
costs associated with an allocated space;
features associated with an allocated space;
whether an allocated space is shared;
architectural requirements associated with an allocated space; and
allocation of common spaces.

15. The computer-readable storage medium of claim 13, wherein the space constraint data comprises at least one member of the set of:
physical constraint data;
architectural constraint data;
financial constraint data; and
legal constraint data.

16. The computer-readable storage medium of claim 13, further comprising:
receiving a second BIM comprising a second set of space constraint data associated with a second space, the second BIM received by the IWMS;
processing the first set of organization structure data and the second set of space constraint data to automatically generate a second space layout corresponding to the second space, the processing performed by the IWMS;
performing comparison operations to compare the first space layout to the second space layout, the performance of the comparison operations generating a first set of space utilization metrics respectively associated with the first space layout and the second space layout.

17. The computer-readable storage medium of claim 16, further comprising:
processing the first set of space utilization metrics with the first set of organization structure data to determine the optimum space layout.

18. The computer-readable storage medium of claim 17, further comprising:
processing the first set of organization structure data to generate a second set of organization structure date, the processing comprising performing revisions to the first set of organization structure data;
processing the second set of organization structure data with the first and second sets of space constraint data to automatically generate a third space layout corresponding to the first space and a fourth space layout corresponding to the second space, the processing performed by the IWMS;
performing comparison operations to compare the third space layout to the fourth space layout, the performance of the comparison operations generating a second set of space utilization metrics respectively associated with the third space layout and the fourth space layout; and
processing the second set of space utilization metrics with the second set of organization structure data to determine the optimum space layout.

19. The computer-readable storage medium of claim 13, wherein the computer executable instructions are deployable to a client system from a server system at a remote location.

20. The computer-readable storage medium of claim 13, wherein the computer executable instructions are provided by a service provider to a user on an on-demand basis.
